(19) United States
(12) Patent Application Publication
(10) Pub. No.: US 2014/0263717 A1
(43) Pub. Date: Sep. 18, 2014

(54) Water Effects Device

(71) Applicant: Michael S. Adkins, Vandalia, OH (US)

(72) Inventor: Michael S. Adkins, Vandalia, OH (US)

(73) Assignee: HEARTH PRODUCTS CONTROLS, Kettering, OH (US)

(21) Appl. No.: 14/210,753

(22) Filed: Mar. 14, 2014

Related U.S. Application Data
(60) Provisional application No. 61/792,439, filed on Mar. 15, 2013.

(51) Int. Cl. B05B 17/08

(52) U.S. Cl. CPC B05B 17/08
USPC 239/22

(57) ABSTRACT

Water effects devices including a generally annular pressure chamber having an inlet, an upper wall portion, and at least one horizontally elongated outlet spaced apart from and disposed below the upper wall portion. The pressure chamber may include a baffle configured to block flow along any otherwise uninterrupted straight line extending from the inlet to the outlet. The outlet may include a scupper plate projecting from the outlet opening and away from the outer surface of the pressure chamber. The baffle and the scupper plate may constitute a single sheet of material extending from within the pressure chamber, proximate a wall of the chamber opposite the outlet, to the location away from the outer surface of the pressure chamber. Devices including ornamental housings providing a central void are also disclosed.

### CROSS-REFERENCE TO RELATED APPLICATIONS

This application claims the benefit of U.S. Provisional Application No. 61/792,439, filed on Mar. 15, 2013, the entire contents of which are incorporated herein by reference.

### FIELD

Embodiments of the subject matter described herein relate generally to water effects devices such as fountains and, more particularly, to water effects devices having a pressurized chamber in fluid communication with one or more fluid outlets.

### BACKGROUND

In traditional water effects devices, such as fountains, water is discharged in two typical manners. First, water may be discharged into an open air pool or reservoir, whereupon the water is allowed to spill over a lip, or to overtop a ledge, to form effects ranging from a narrow stream to a broad fan of falling water. Second, water may be discharged through a nozzle, typically directed upwards but in some instances horizontally or even partially downwards, to form effects ranging from a column to a narrow fan to an arcing discharge of water. For the first type of discharge, the device must be carefully leveled so as to prevent the free surface of the water within the pool or reservoir from intersecting with the lip or ledge at less than the intended number of spillways, or along only a fraction of the ledge, due to the greater elevation of some spillways or portions of a ledge than others. If the device is to provide effects at multiple elevations, such as in a tiered fountain, the device ordinarily also incorporates multiple open air pools or reservoirs, each of which supply water to a different elevation. For the second type of discharge, leveling is less of a consideration since the water will be pressurized upstream of the nozzle, e.g., within a supply line or internal reservoir, yet the nozzles themselves are ill-adapted to create effects such as broad, laminar fans of falling water, and generally unable to generate non-point source, annular fans of falling water having central voids capable of housing fire effects, planters, miniature stone gardens, or other decorative features. Although some hybrid devices are known, such devices are usually linear, provide only a single outlet for a water effect, and do not address each of the deficiencies identified above.

### SUMMARY

Presented is a water effects device having a generally annular pressure chamber including an upper wall and at least one horizontally elongated outlet spaced apart from and disposed below that upper wall. The annular pressure chamber lessens the need to accurately level the water effects device, enables the provision of multiple outlets at multiple elevations, and enables the provision of a fully circumannular outlet having a more uniform discharge profile. The horizontally elongated outlets may produce a broad, laminar fan of falling water resembling a waterfall effect.

In a first aspect, a water effects device includes a generally annular pressure chamber having an inlet, an upper wall portion, and at least one horizontally elongated outlet spaced apart from and disposed below the upper wall portion. The pressure chamber preferably includes a baffle configured to block flow along any otherwise uninterrupted straight line extending from the inlet to the outlet. The outlet preferably includes scupper plate projecting from the outlet opening and away from the outer surface of the pressure chamber. The baffle and the scupper plate may constitute a single sheet of material extending from within the pressure chamber, proximate a wall of the chamber opposite the outlet, to the location away from the outer surface of the pressure chamber.

In a second aspect, a water effects device includes a housing and a generally annular pressure chamber having an inlet, an upper wall portion, and at least one horizontally elongated outlet spaced apart from and disposed below the upper wall portion. The housing supports the pressure chamber, and may partially or essentially completely surround the pressure chamber to provide an ornamental exterior surface. The pressure chamber preferably includes a baffle configured to block flow along any otherwise uninterrupted straight line extending from the inlet to the outlet. The outlet preferably includes scupper plate projecting outward from the outlet opening and radially beyond the housing. The baffle and the scupper plate may constitute a single annular sheet of material extending from within the pressure chamber, proximate an inner wall of the pressure chamber, to the location radially beyond the housing.

Many of the features and functions discussed herein may be achieved independently or in combination in various embodiments, as will be seen with reference to the following description and drawings.

### BRIEF DESCRIPTION OF THE DRAWINGS

The accompanying figures depict various aspects of the disclosed water effects device. A brief description of each figure is provided below.

FIG. 1 is a perspective view of one embodiment of the water effects device.

FIG. 2 is a top view of the device of FIG. 1. Section line A refers to the section shown in FIGS. 3 and 5. Section line B refers to the sections shown in FIGS. 4 and 6.

FIG. 3 is a side section of the device along line A of FIG. 2. Hatching is not used in this figure due to scale. The location of the detail section provided in FIG. 5 is shown for reference.

FIG. 4 is a perspective section of the device along line B of FIG. 2. Hatching is not used in this figure due to scale. The location of the detail section provided in FIG. 6 is shown for reference.

FIG. 5 is a detailed side section of the pressure chamber along line A of FIG. 2.

FIG. 6 is a detailed perspective section of the pressure chamber along line B of FIG. 2.

FIG. 7 is a perspective view of another embodiment of the water effects device.

FIG. 8 is a top view of the device of FIG. 7. Section line A refers to the section shown in FIGS. 9 and 10.

FIG. 9 is a perspective section of the device along line A of FIG. 8. Hatching is not used in this figure due to scale. The location of the detail section provided in FIG. 10 is shown for reference.

FIG. 10 is a detailed perspective section of the pressure chamber along line A of FIG. 8.

### DETAILED DESCRIPTION

With initial reference to FIGS. 1 and 7, a water effects device 100 comprises a generally annular pressure chamber 110 including an upper wall 120 and at least one horizontally elongated outlet 130 spaced apart from and disposed below that upper wall. As shown in corresponding FIGS. 2 and 8, specific embodiments of the generally annular pressure chamber may have a strictly annular plan, but those of skill will appreciate that the generally annular pressure chamber may have any of a number of other closed and hollow geometric plans, including plans defined by concentric triangles, squares, pentagons, etc., as well as other nested regular and/or irregular shapes. Consequently, the term “generally annular” should be construed as meaning ring-shaped, but not necessarily circular (or toroidal, upon considering the third dimension), when used herein. As shown in FIGS. 1 and 2, in some embodiments the device 100 may include a plurality of horizontally elongated outlets 130. However, as shown in FIGS. 7 and 8, the device may include a single horizontally elongated outlet 130, which may be a fully circumannular, horizontally elongated outlet extending around the entire circumference of the pressure chamber 110. Those of skill will further appreciate that while the outlets 130 in the illustrations are directed radially outwardly from a radially outward wall of the pressure chamber 110, in other embodiments the outlets 130 may instead be directed radially inwardly from a radially inward wall of the pressure chamber 110, or, where there are multiple outlets, in varying combinations thereof.

The generally annular pressure chamber 110 of the device 100 further includes an inlet 140, but is otherwise substantially airtight. The pressure chamber 110 may then be dynamically pressurized by water introduced through the inlet 140, which upon rising to the level of outlet(s) 130 may trap and pressurize a pocket of air against upper wall 120. The dimensions and water pressure at inlet 140, versus the dimensions of outlet(s) 130, serve to positively pressurize the water and any trapped air with respect to the outside atmosphere. For example, in a device having two inlets 140, fed by a 3200 gallon-per-hour (gph) pump through 1 and ¼ inch supply lines, and four outlets 130, each approximately 9 and ⅞ inches long by ⅛ inch high, operating pressure at the upper wall 120 was determined to be approximately 0.15 pounds per square inch above atmospheric pressure (psig)—equivalent to about 4 and ⅛ inches of static head. Due to the pressurization of the pressure chamber 110, minor differences in the actual elevation of outlets 130 ideally provided at the same elevation constitute only a small fraction of the pressure differential between the water flowing through an outlet 130 and the outside atmosphere. For example, in a 26 inch diameter device set off-level by only 1 degree, oppositely disposed outlets 130 may differ in actual elevation by as much as ½ inch, yet that difference in elevation would represent less than 13% of the pressure differential across each outlet. If the pump were operated at lower speed or the outlet dimensions enlarged, pressure at the upper wall 120 would decrease, approaching atmospheric pressure, but for appropriate balances of pump speed/flow rate, outlet dimensions, device dimensions, and leveling tolerance, this appreciable benefit remains.

In addition, those of skill will recognize that the pressure chamber 110 enables embodiments in which multiple outlets 130 may be disposed at different elevations and supplied with water from the same pressure chamber. Thus, turning to FIG. 3 as a partial illustration of the general concept, one opposing pair of outlets 130 may be spaced apart from and disposed below upper wall 120 by a first distance, d₁, and another opposing pair of outlets 130 (not visible in this section) may be spaced apart from and disposed below upper wall 120 by a different second distance, d₂. As in the discussion of the leveling advantage above, a difference in the distances d₁ and d₂ of ½ inch would represent less than 13% of the pressure differential across each outlet, resulting in similar, but not identical, discharge effects. For appropriate balances of pump speed/flow rate, outlet dimensions, and outlet elevations, this appreciable benefit may remain. Alternately, greater differences in pressure differential across each outlet, due to lesser pressurization of the pressure chamber 110 and/or greater differences in elevation between outlets 130, permit effects similar to the appearance of a tiered fountain without requiring the use of multiple open air pools or reservoirs, providing a different but still appreciable benefit.

Turning to FIGS. 2 and 4, in one exemplary embodiment of the water effects device 100, the device includes four circumferentially spaced-apart outlets 130 and a pair of inlets 140, each disposed on opposite ends of the pressure chamber 110 between adjacent outlets 130. The pressure chamber 110 preferably includes at least one baffle 150 configured to block flow along any otherwise uninterrupted straight line extending from an inlet 130 to an outlet 140. For sake of clarity, the term “otherwise uninterrupted straight line” in this context means a straight line which does not intersect a wall of the pressure chamber 110 between origin and endpoint. As suggested by FIG. 4, baffle 150 may be a single, generally annular baffle extending from proximate a wall of the pressure chamber 110 opposite each outlet 130 to each respective outlet, and dividing the pressure chamber 110 into a lower portion 112 and upper portion 114. Inlets 140 may then be positioned within the lower portion 112, and outlets 130 within the upper portion. However, there may be a plurality of baffles 150, preferably equal in number to the number of outlets 130, each extending from proximate a wall of the pressure chamber 110 opposite an outlet 130 to that outlet. For reasons explained below, preferably baffle 150 is oriented principally horizontally within the pressure chamber 110, but those of skill will appreciate that baffle 150 may be oriented vertically, or in any orientation therebetween, in more complex constructions. Moreover, as shown baffle 150 extends from proximate a radially inner wall 116 of the pressure chamber 110 to outlets 130 in a radially outer wall 118 of the pressure chamber. However, in view of the initial paragraph of this description, baffle 140 may extend from proximate a radially outer wall 118 of the pressure chamber 110 to outlets in a radially inner wall 116 of the pressure chamber.

Turning to FIG. 5, the outlets 130 preferably each include a scupper plate 160 projecting from each outlet opening and away from the outer surface of the pressure chamber 110. Scupper plate 160 may be oriented horizontally with respect to outlet 130, or principally horizontally but downward with respect to outlet 130, to produce a broad, laminar waterfall effect. Preferably, the baffle 150 and the scupper plate 160 constitute a single sheet of material extending from within the pressure chamber to the location away from the outer surface of the pressure chamber 110, i.e., the projecting end of the scupper plate 160. As shown in the figure, the baffle 150 and the scupper plates 160 may constitute a single, generally annular, substantially planar sheet of material; however those of skill will appreciate that the sheet may be bent, e.g., at the outer wall 118 of the pressure chamber 110 or the outlet 130, to have differing orientations. This combination of baffle 150 and scupper plate 160 simplifies the construction of the pressure chamber 110 and outlet 130 both in part count and length of material to be welded, adhered, or otherwise joined.

Turning to FIG. 6, the outlets 130 may also each include a pair of opposing side plates 170 disposed at the horizontal ends of the outlet. The pair of opposing side plates 170 preferably extend from within the pressure chamber 110 to a location away from the outer surface of the pressure chamber to prevent disruption of a laminar flow of water out of outlet 130 by edge effects. As shown in FIGS. 1-6, scupper plate 160 and side plates 170 may extend from outlet 130 radially beyond a housing 180. Housing 180 supports the pressure chamber 110 and may partially or essentially completely (excepting outlets 130 and inlets 140) surround the pressure chamber to provide an ornamental exterior surface. Housing 180 is preferably bowl-shaped, and provides a central void 190 for the connection of supply lines to inlets 140, for fire effects devices, or for ornamental features such as planters, miniature stone gardens, and the like. However, in view of the initial paragraph of this description, scupper plate 160 and side plates 170 may extend from outlets 130 in a radially inner wall 116 of the pressure chamber 110 and radially inward into the central void 190. In such constructions, the central void 190 may serve as a supply reservoir for a pump, as a water garden, as a hydroponic planter, or the like.

Referring now to FIGS. 7 and 9, in another exemplary embodiment of the water effects device 100, the device includes a fully circumannular, horizontally elongated outlet 130 extending around the entire circumference of the pressure chamber 110. The height of the circumannular, horizontally elongated outlet 130 may be adjusted to provide an opening equivalent in area to that of other designs, e.g., that of the above-disclosed four outlet example.

For example, in a 26 inch diameter device, a 1/16 inch high circumannular outlet has approximately the same opening area, 5.10 versus 4.95 square inches, and would be expected to have the same operating pressure at the upper wall 120 with the same pump conditions—0.15 psig or about 4 and ⅛ inches of static head. However, those of skill will appreciate that other appropriate balances of pump speed/flow rate, outlet dimensions, device dimensions, and leveling tolerance, and, in devices including multiple circumannular outlets at different elevations, outlet elevations will exist.

The pressure chamber 110 preferably includes a baffle 150 configured to block flow along any otherwise uninterrupted straight line extending from an inlet 130 to the outlet 140, and the baffle is preferably a single, generally annular baffle extending from proximate a wall of the pressure chamber 110 opposite the outlet 130 to the outlet itself, dividing the pressure chamber 110 into a lower portion 112 and upper portion 114. A pair of inlets 140 may then be positioned within the lower portion 112, and the outlet 130 within the upper portion. However, as in the earlier exemplary embodiment, there may be a plurality of baffles 150, each extending from proximate a wall of the pressure chamber 110 opposite the outlet 130 to the outlet itself. Baffle 150 is preferably oriented principally horizontally within the pressure chamber 110, but may be otherwise oriented as described above. Again, as shown baffle 150 extends from proximate a radially inner wall 116 of the pressure chamber 110 to the outlet 130 in a radially outer wall 118 of the pressure chamber, but may alternately extend from proximate a radially outer wall of the pressure chamber to an outlet in a radially inner wall 116 of the pressure chamber.

Turning to FIG. 10, outlet 130 preferably includes a scupper plate 160 projecting from the outlet opening and away from the outer surface of the pressure chamber 110. Scupper plate 160 may be oriented horizontally with respect to outlet 130, or as a depending surface of a frustrum, to produce a circumannular and laminar waterfall effect. Preferably, the baffle 150 and the scupper plate 160 constitute a single sheet of material extending from within the pressure chamber 110 to the location away from the outer surface of the pressure chamber 110. Again, as shown in the figure, the baffle 150 and the scupper plate 160 may constitute a single, generally annular, substantially planar sheet of material; however those of skill will appreciate that the sheet may be bent, e.g., at the outer wall 118 of the pressure chamber 110 or the outlet 130, to have differing orientations. This combination of baffle 160 and scupper plate 160 simplifies the construction of the pressure chamber 110 and outlet 130 both in part count and length of material to be welded, adhered, or otherwise joined, and may serve to center the combined parts with respect to the circumference of the device.

As shown in FIGS. 7-10, scupper plate 160 extends from outlet 130 radially beyond a housing 180. Housing 180 supports the pressure chamber 110 and may partially or essentially completely surround the pressure chamber 110 to provide an ornamental exterior surface. Housing 180 is preferably bowl-shaped, and provides a central void 190 for the connection of supply lines to inlets 140, for fire effects devices, or for ornamental features such as planters, miniature stone gardens, and the like. However, in view of the initial paragraph of this description, scupper plate 160 may extend from an outlet 130 in a radially inner wall 116 of the pressure chamber and radially inward into the central void 190. In such constructions, the central void 190 may serve as a supply reservoir for a pump, as a water garden, as a hydroponic planter, or the like. Additionally, multiple such outlets 130 may be provided at different elevations, with intermediate portions of the pressure chamber walls being supported by perforated baffles, internal ribs, or other circumferentially discontinuous bridging structures apparent to those of skill in the mechanical arts.

The embodiments of the invention shown in the drawings and described above are exemplary of numerous embodiments that may be made within the scope of the appended claims. It is contemplated that numerous other configurations of the device, employing various combinations and orientations of outlets and associated structures may be created based on recombinations of the discussed features and illustrated examples. It is the applicant's intention that the scope of the patent issuing herefrom will be limited only by the scope of the claims and specific definitions provided herein.

What is claimed is:

1. A water effects device comprising a generally annular pressure chamber having:
an inlet;
an upper wall portion; and
at least one horizontally elongated outlet;
wherein the at least one horizontally elongated outlet is spaced apart from the upper wall portion and disposed below the upper wall portion.

2. The water effects device of claim 1, wherein the at least one horizontally elongated outlet is disposed on a radially outer wall of the pressure chamber.

3. The water effects device of claim 2, wherein the at least one horizontally elongated outlet is a fully circumannular, horizontally elongated outlet.

4. The water effects device of claim 2, wherein the at least one horizontally elongated outlet comprises a plurality of separate horizontally elongated outlets.

5. The water effects device of claim 4, wherein one of the plurality of separate horizontally elongated outlets is spaced apart from and disposed below the upper wall portion by a different distance than another of the plurality of separate horizontally elongated outlets.

6. The water effects device of claim 1, further comprising a baffle configured to block flow along any otherwise interrupted straight line extending from the inlet to the at least one horizontally elongated outlet.

7. The water effects device of claim 6, wherein the baffle is a generally annular baffle extending from proximate a wall of the pressure chamber opposite the at least one horizontally elongated outlet to each respective outlet.

8. The water effects device of claim 1, further comprising a scupper plate projecting from the opening of the at least one horizontally elongated outlet and away from an outer surface of the pressure chamber.

9. The water effects device of claim 8, wherein the at least one horizontally elongated outlet is a fully circumannular, horizontally elongated outlet, and wherein the scupper plate is a generally annular scupper plate projecting from the opening of the fully circumannular, horizontally elongated outlet and away from an outer surface of the pressure chamber.

10. The water effects device of claim 1, further comprising:
a baffle configured to block flow along any otherwise interrupted straight line extending from the inlet to the at least one horizontally elongated outlet; and
a scupper plate projecting from the opening of the at least one horizontally elongated outlet and away from an outer surface of the pressure chamber;
wherein the baffle and the scupper plate constitute a single sheet of material extending from within the pressure chamber to the location away from the outer surface of the pressure chamber.

11. A water effects device comprising:
a housing; and
a generally annular pressure chamber having
an inlet,
an upper wall portion, and
at least one horizontally elongated outlet;
wherein the at least one horizontally elongated outlet is spaced apart from the upper wall portion and disposed below the upper wall portion, and wherein the housing supports the generally annular pressure chamber.

12. The water effects device of claim 11, wherein the at least one horizontally elongated outlet is a fully circumannular, horizontally elongated outlet disposed on a radially outer wall of the pressure chamber.

13. The water effects device of claim 12, further comprising a baffle configured to block flow along any otherwise interrupted straight line extending from the inlet to the fully circumannular, horizontally elongated outlet, wherein the baffle is a generally annular baffle extending from proximate a radially inner wall of the pressure chamber to the fully circumannular, horizontally elongated outlet.

14. The water effects device of claim 13, further comprising a scupper plate projecting from the opening of the fully circumannular, horizontally elongated outlet and radially beyond the housing.

15. The water effects device of claim 14, wherein the baffle and the scupper plate constitute a single annular sheet of material extending from within the pressure chamber, proximate the radially inner wall of the pressure chamber, to the location radially beyond the housing.

16. The water effects device of claim 15, wherein the single, annular sheet of material is substantially planar.

17. The water effects device of claim 11, wherein the at least one horizontally elongated outlet is plurality of circumferentially spaced-apart outlets disposed on a radially outer wall of the pressure chamber.

18. The water effects device of claim 17, further comprising a baffle configured to block flow along any otherwise interrupted straight line extending from the inlet to any of the plurality of circumferentially spaced-apart outlets, wherein the baffle is a generally annular baffle extending from proximate a radially inner wall of the pressure chamber to each of the plurality of circumferentially spaced-apart outlets.

19. The water effects device of claim 18, further comprising a plurality of scupper plates, each projecting from the opening of one of the plurality of of circumferentially spaced-apart outlets and radially beyond the housing.

20. The water effects device of claim 19, wherein the baffle and the plurality of scupper plates constitute a single annular sheet of material extending from within the pressure chamber, proximate the radially inner wall of the pressure chamber, to the locations radially beyond the housing.

21. The water effects device of claim 10, wherein the single, annular sheet of material is substantially planar.
